(19) United States
(12) Patent Application Publication
(10) Pub. No.: US 2021/0006123 A1
(43) Pub. Date: Jan. 7, 2021

(54) ELECTRIC ROTARY MACHINE CASE AND VEHICLE

(71) Applicant: HONDA MOTOR CO., LTD., Tokyo (JP)

(72) Inventors: Keiichiro KASHIWABARA, Saitama (JP); Rintaro ENDO, Saitama (JP); Atsushi NISHIDA, Saitama (JP)

(73) Assignee: HONDA MOTOR CO., LTD., Tokyo (JP)

(21) Appl. No.: 16/919,413

(22) Filed: Jul. 2, 2020

(30) Foreign Application Priority Data
Jul. 2, 2019 (JP) 2019-123961

(51) Int. Cl. H02K 5/20; B60K 1/00; B60K 11/02; H02K 7/00; H02K 9/19

(52) U.S. Cl. CPC H02K 5/20; B60K 1/00; B60K 2001/006; H02K 7/006; H02K 9/19; B60K 11/02

(57) ABSTRACT

An electric rotary machine case, which has a cylindrical shape and accommodates an electric rotary machine, includes a passage extending along a rotation axis direction of the electric rotary machine on an outer periphery of the electric rotary machine, and a protrusion portion protruding radially outward from an outer peripheral surface of the electric rotary machine case, the protrusion portion having the passage formed inside the protrusion portion. The protrusion portion has a flat surface in a cross-section orthogonal to a rotation axis of the electric rotary machine.

### CROSS-REFERENCE TO RELATED APPLICATIONS

This application is based on and claims priority under 35 USC 119 from Japanese Patent Application No. 2019-123961 filed on Jul. 2, 2019.

### TECHNICAL FIELD

The disclosure relates to an electric rotary machine case accommodating an electric rotary machine and a vehicle equipped with the electric rotary machine case.

### BACKGROUND ART

In recent years, an electric rotary machine, which is a drive source for an electric vehicle or the like, is accommodated in an electric rotary machine case and mounted on the electric vehicle. Further, a technique, in which an electric rotary machine case accommodating an electric rotary machine is provided with an oil discharge passage extending along a rotation axis direction of the electric rotary machine and oil passing through the oil discharge passage is circulated, is known (for example, see FIG. 4 of JP-A-2006-197772).

### SUMMARY OF INVENTION

When an electric rotary machine case is provided with a passage (hereinafter referred to as a lubricating oil passage) through which lubricating oil (oil) or the like flows as in the related art described above, the rigidity of the location, where the lubricating oil passage is provided, is reduced. In order to prevent the decrease in rigidity, it is possible to increase the thickness of the electric rotary machine case. However, when the thickness of the entire electric rotary machine case is increased, the weight of the electric rotary machine case will increase.

On the other hand, by providing the electric rotary machine case with a protrusion portion which protrudes radially outward from an outer peripheral surface of the electric rotary machine case and forming a lubricating oil passage inside the protrusion portion, the weight increase of the electric rotary machine case can be avoided. However, in this case, when a large stress is locally generated in the protrusion portion, the electric rotary machine case may be damaged.

An object of the disclosure is to provide an electric rotary machine case and a vehicle capable of preventing a large stress from being locally generated in a location where a passage is provided in the electric rotary machine case while suppressing an increase in weight.

According to an aspect of the disclosure, there is provided an electric rotary machine case, which has a cylindrical shape and accommodates an electric rotary machine, the electric rotary machine case including: a passage extending along a rotation axis direction of the electric rotary machine on an outer periphery of the electric rotary machine; and a protrusion portion protruding radially outward from an outer peripheral surface of the electric rotary machine case, the protrusion portion having the passage formed inside the protrusion portion, in which: the protrusion portion has a flat surface in a cross-section orthogonal to a rotation axis of the electric rotary machine.

According to an aspect of the disclosure, there is provided a vehicle including the electric rotary machine case described above, in which: the electric rotary machine case is arranged below a passenger compartment or a luggage compartment of the vehicle, and the flat surface is provided below the rotation axis and further on a front side or rear side of the vehicle than the rotation axis.

According to the disclosure, it is possible to prevent that a large stress is locally generated in the location where the passage is provided in the electric rotary machine case while suppressing an increase in weight.

### BRIEF DESCRIPTION OF DRAWINGS

FIG. 1 is a perspective view illustrating an electric rotary machine case according to an embodiment of the disclosure.

FIG. 2 is a cross-sectional view of the electric rotary machine case of FIG. 1 accommodating an electric rotary machine taken along a rotation axis direction.

FIG. 3 is a cross-sectional view of the electric rotary machine case of FIG. 1 accommodating the electric rotary machine taken along a direction orthogonal to the rotation axis direction.

FIG. 4 is a schematic side view of a vehicle of an embodiment in which the electric rotary machine case of FIG. 1 is mounted.

FIG. 5 is a plan view illustrating an underfloor structure of the vehicle in FIG. 4.

FIG. 6 is a perspective view of a sub-frame and a drive unit of the vehicle in FIG. 4 as viewed from the lower left and the front.

FIG. 7 is a view of the sub-frame and the drive unit of the vehicle in FIG. 4 as viewed from above.

FIG. 8 is a rear view of the sub-frame and the drive unit of the vehicle in FIG. 4.

FIG. 9 is a view illustrating the sub-frame and the drive unit taken along a section line A-A in FIG. 8.

### DESCRIPTION OF EMBODIMENT

Hereinafter, an electric rotary machine case according to an embodiment of the disclosure and a vehicle equipped with the electric rotary machine case will be described with reference to the drawings.

[Electric Rotary Machine Case]

First, the electric rotary machine case of the embodiment will be described. In the following description of the electric rotary machine case of the embodiment, a direction orthogonal to an up-down direction (vertical direction) is set as a horizontal direction and two directions orthogonal to the horizontal direction are set as a front-rear direction and a left-right direction. Further, in the drawings, the front side of the electric rotary machine case is shown as Fr, the rear side as Rr, the left side as L, the right side as R, the upper side as U, and the lower side as D. However, those directions may be different from the directions when the electric rotary machine case is mounted on a vehicle or the like.

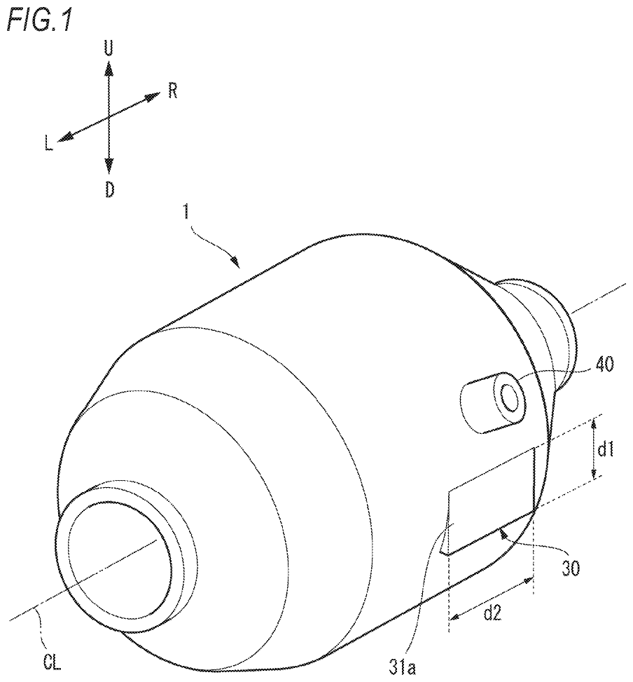

As illustrated in FIGS. 1 to 3, an electric rotary machine case 1 of the embodiment is mounted on an electric vehicle as a component of a drive unit which accommodates an electric rotary machine MOT having a rotation axis CL extending in the horizontal direction and which drives front wheels or rear wheels using the electric rotary machine MOT as a drive source. The rotation axis CL is the rotation axis center of the electric rotary machine MOT.

The electric rotary machine case 1 is formed in a substantially cylindrical shape and an accommodation portion 10 for accommodating the electric rotary machine MOT is provided inside. Lubricating oil LB is stored below the accommodation portion 10 of the electric rotary machine case 1. In addition, the electric rotary machine case 1 includes a lubricating oil passage 20 through which the lubricating oil LB lubricating the electric rotary machine MOT passes and a protrusion portion 30 which protrudes radially outward from an outer peripheral surface of the electric rotary machine case 1. In FIG. 1, reference numeral 40 denotes a rear fastening portion fastened to a frame member of the vehicle when the electric rotary machine case 1 is mounted on the vehicle.

The lubricating oil passage 20 is formed inside the protrusion portion 30 and is provided on the outer periphery of the electric rotary machine MOT in the electric rotary machine case 1 so as to extend in a direction (hereinafter referred to as the rotation axis direction) along the rotation axis CL of the electric rotary machine MOT. By providing the protrusion portion 30 and forming the lubricating oil passage 20 inside the protrusion portion 30, while preventing the radial thickness (wall thickness) of the entire electric rotary machine case 1 from increasing, it is possible to secure a space for providing the lubricating oil passage 20 in the electric rotary machine case 1.

The lubricating oil passage 20 is a passage for guiding the lubricating oil LB injected into the accommodation portion 10 toward an oil pan (not illustrated) provided outside the electric rotary machine case 1. The lubricating oil passage 20 is provided below the rotation axis CL. By providing the lubricating oil passage 20 below the rotation axis CL, the lubricating oil in the accommodation portion 10 can be efficiently collected by utilizing gravity.

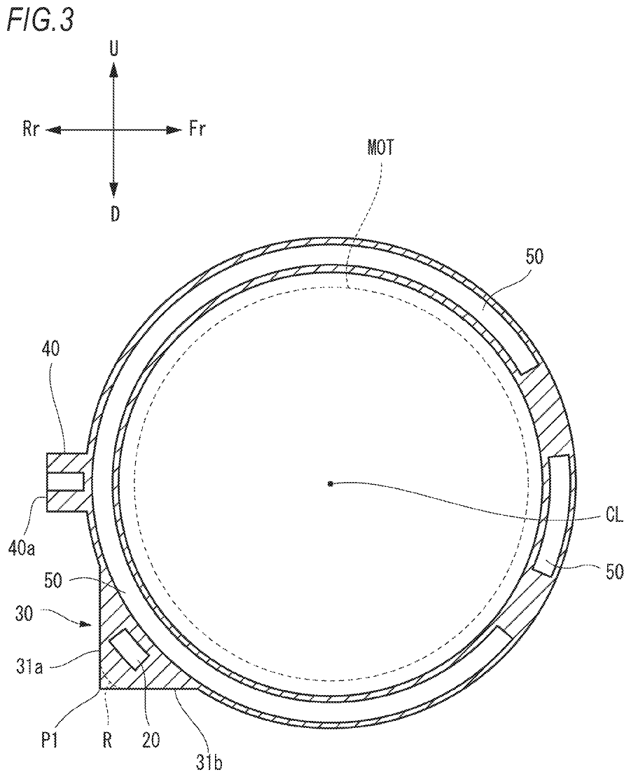

As illustrated in FIG. 3, the protrusion portion 30 has two flat surfaces 31a and 31b in a cross-section orthogonal to the rotation axis CL. Although the rigidity of the protrusion portion 30 is reduced due to the formation of the lubricating oil passage 20 inside, the protrusion portion 30 is provided with the flat surfaces 31a and 31b. Therefore, when an object comes into contact with the protrusion portion 30, it is possible to prevent a large stress from being locally generated on the protrusion portion 30.

More specifically, in a cross-section orthogonal to the rotation axis CL, the two flat surfaces 31a and 31b include the flat surface 31a which is a surface connecting an outermost diameter portion P1 of the protrusion portion 30 and the outer peripheral surface of the electric rotary machine case 1 in the up-down direction and the flat surface 31b which is a surface connecting the outermost diameter portion P1 of the protrusion portion 30 and the outer peripheral surface of the electric rotary machine case 1 in the horizontal direction.

The rigidity of the protrusion portion 30 can be improved by providing the flat surface 31a in which the outermost diameter portion P1 and the outer peripheral surface of the electric rotary machine case 1 are vertically connected to each other to have a thick wall. In particular, it is possible to prevent a large stress from being locally generated in the protrusion portion 30 when an object comes into contact with the protrusion portion 30 (flat surface 31a) from the outside (the left side in FIG. 3) in the direction orthogonal to the rotation axis direction and the up-down direction.

Further, the flat surface 31a has a length d2 in the rotation axis direction which is longer than a length d1 in the up-down direction. Therefore, even when the lubricating oil passage 20 is formed so as to extend in the rotation axis direction, the flat surface 31a formed long in the rotation axis direction can suppress the decrease in the rigidity of the protrusion portion 30.

Similarly, the rigidity of the protrusion portion 30 can be improved by providing the flat surface 31b in which the outermost diameter portion P1 and the outer peripheral surface of the electric rotary machine case 1 are horizontally connected to each other to have a thick wall. In particular, it is possible to prevent a large stress from being locally generated in the protrusion portion 30 when an object comes into contact with the protrusion portion 30 (flat surface 31b) from the outside (the lower side in FIG. 3) in the up-down direction.

In this embodiment, the flat surface 31a and the flat surface 31b are configured to intersect each other at a right angle, but it is preferable that the corner formed by the flat surface 31a and the flat surface 31b be rounded as indicated by a reference numeral R in the drawing.

The electric rotary machine case 1 further includes a refrigerant passage 50 through which a refrigerant cooling the electric rotary machine MOT passes. The refrigerant passage 50 is a water jacket through which cooling water for cooling the electric rotary machine MOT passes. The refrigerant passage 50 is formed in the outer peripheral portion of the electric rotary machine MOT in the electric rotary machine case 1 along a circumferential direction of the electric rotary machine case 1. When such the refrigerant passage 50 is provided, the lubricating oil passage 20 is arranged outside of the refrigerant passage 50 in the radial direction. That is, an overlapping portion P2, where the lubricating oil passage 20 and the refrigerant passage 50 overlap in the radial direction of the electric rotary machine case 1, is generated.

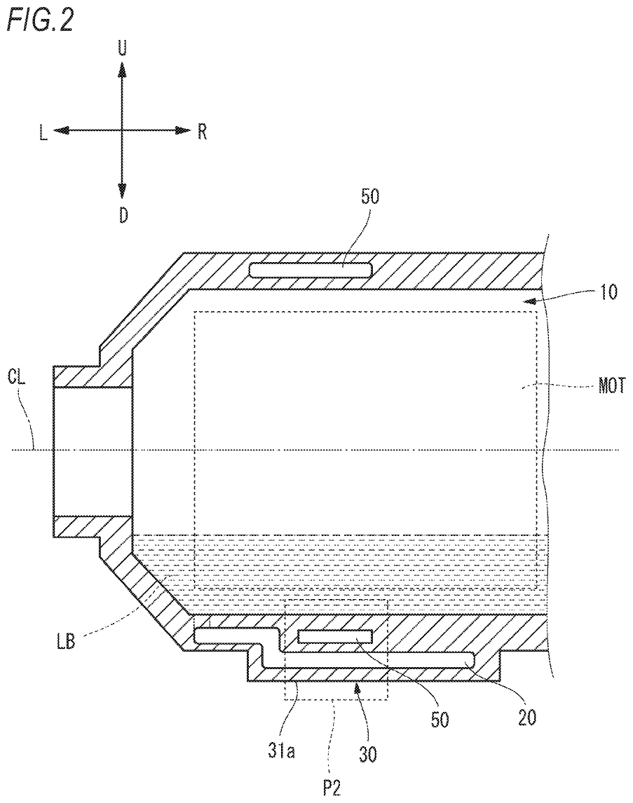

In the overlapping portion P2, since both the lubricating oil passage 20 and the refrigerant passage 50 are formed, the rigidity is further reduced. Therefore, in the electric rotary machine case 1, by providing the flat surfaces 31a and 31b at the location corresponding to the overlapping portion P2, as illustrated in FIG. 2, it is possible to prevent a large stress from being locally generated at the location.

[Vehicle]

Next, an embodiment of a vehicle equipped with the electric rotary machine case 1 of the embodiment described above will be described.

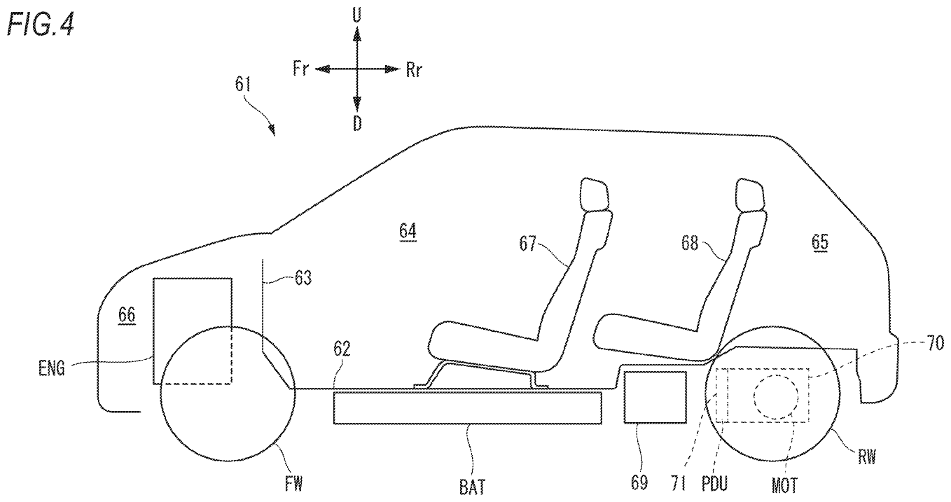

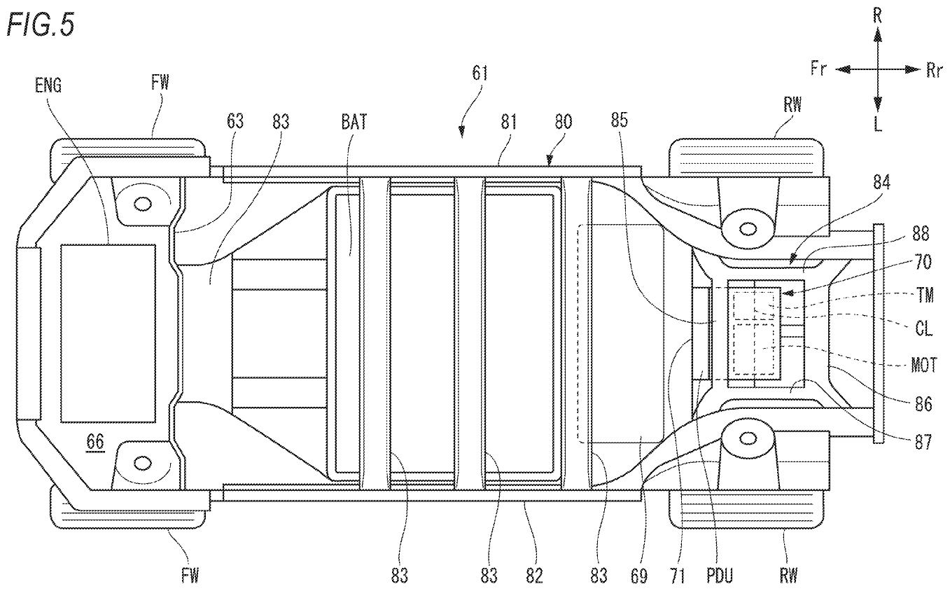

As illustrated in FIGS. 4 and 5, a vehicle 61 is partitioned by a floor panel 62 and a dash panel 63 into a passenger compartment 64 and a luggage compartment 65, and a front room 66 in front of the compartments. The passenger compartment 64 is provided with a front seat 67 and a rear seat 68. The front room 66 is provided with an engine ENG as a drive source for driving left and right front wheels FW. A drive unit 70 including the electric rotary machine MOT as a drive source for driving left and right rear wheels RW is provided below the luggage compartment 65. That is, the vehicle 61 is a so-called hybrid vehicle which uses both the engine ENG and the electric rotary machine MOT as drive sources.

A battery BAT and a fuel tank 69 are arranged below the passenger compartment 64. The battery BAT and the drive unit 70 are connected via a DC line (not illustrated) and the engine ENG and the fuel tank 69 are connected via a fuel pipe (not illustrated).

A vehicle body frame 80 includes a pair of left and right side frames 81 and 82 extending in the front-rear direction, a plurality of cross members 83 extending in a vehicle width direction and connecting the side frames 81 and 82, and a sub-frame 84 supporting the drive unit 70 and having a substantially rectangular shape in plan view.

[Drive Unit]

The drive unit 70 includes the electric rotary machine MOT, the electric rotary machine case 1 for accommodating the electric rotary machine MOT, a power conversion device PDU which is electrically connected to the electric rotary machine MOT and which converts power supplied to the electric rotary machine MOT and power supplied from the electric rotary machine MOT, and a power transmission mechanism TM for transmitting the power of the electric rotary machine MOT to the rear wheels RW. The power conversion device PDU is, for example, an inverter. The power conversion device PDU is provided with a connector portion (not illustrated) to which a DC line connector of a DC line is connected.

The drive unit 70 is supported by the sub-frame 84 such that the rotation axis CL of the electric rotary machine MOT extends in a vehicle width direction and a front wall 71 of the power conversion device PDU faces the front of the vehicle 61. Specifically, the electric rotary machine case 1 includes a rear fastening portion 40 provided on the rear surface of the electric rotary machine case 1 described above, a right front fastening portion (not illustrated) provided on the right side portion of the front surface of the electric rotary machine case 1, and a left front fastening portion (not illustrated) provided on the left side portion of the front surface of the electric rotary machine case 1. The drive unit 70 is supported by the sub-frame 84 by fixing those fastening portions to the sub-frame 84.

[Sub-Frame]

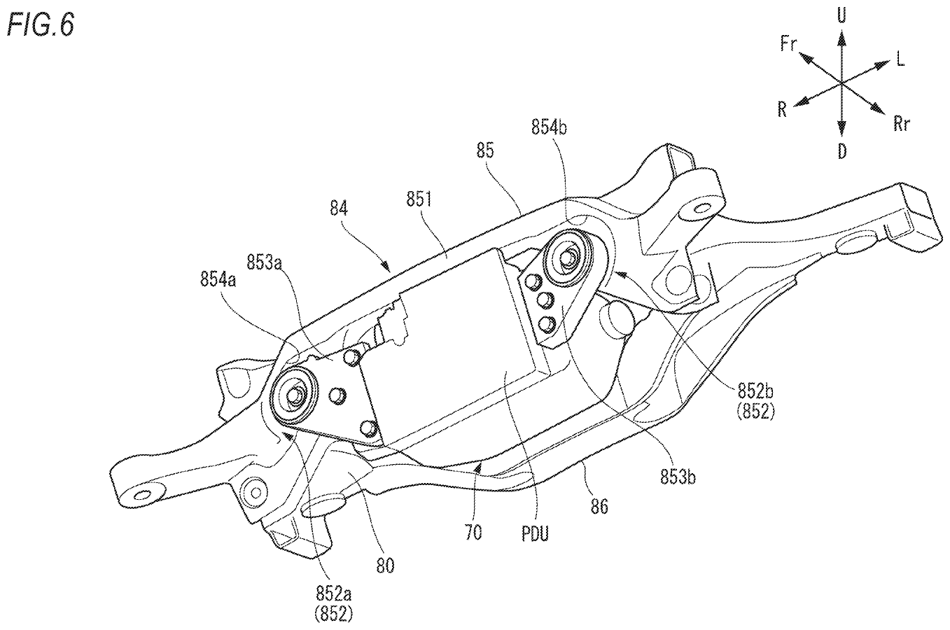

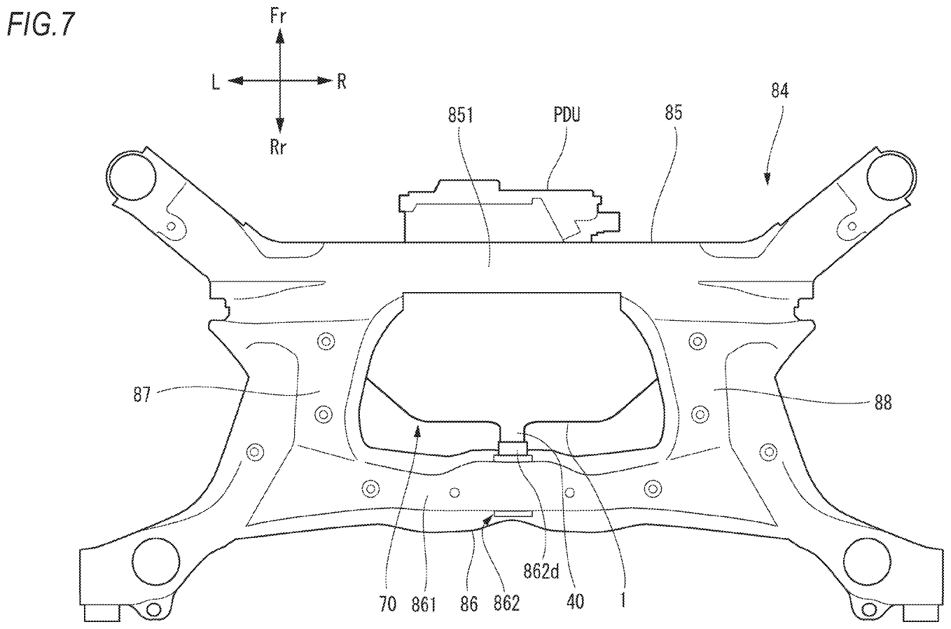

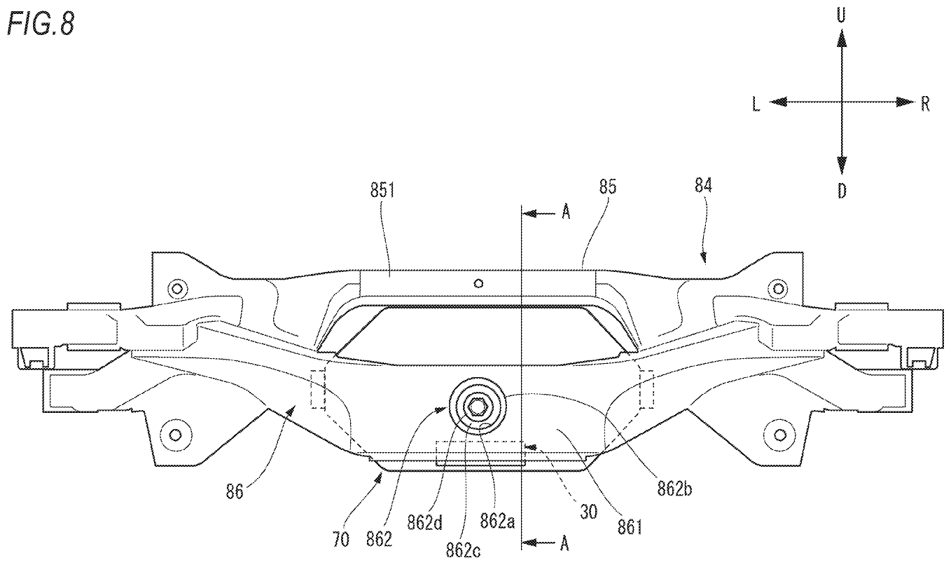

As illustrated in FIGS. 6 to 9, the sub-frame 84 includes a front frame member 85 and a rear frame member 86 facing each other in the front-rear direction and a left frame member 87 and a right frame member 88 facing each other in the vehicle width direction (left-right direction). The front frame member 85, the rear frame member 86, the left frame member 87, and the right frame member 88 are connected to adjacent frame members (for example, the left frame member 87 and the right frame member 88 in the case of the front frame member 85). Thereby, the sub-frame 84 is formed in a substantially rectangular shape in a plan view.

The front frame member 85 includes an upper frame portion 851 which extends above the drive unit 70 in the vehicle width direction and support portions 852 provided on both sides of the upper frame portion 851 in the vehicle width direction. The upper frame portion 851 is a hollow bar member extending in the vehicle width direction. The support portion 852 includes a right support portion 852a provided on the right side of the upper frame portion 851 and a left support portion 852b provided on the left side of the upper frame portion 851 when viewed from the front.

The right support portion 852a has a bolt hole (not illustrated) communicating with a bolt hole of a right mount bracket 853a inside an inner wall portion 854a provided so as to surround the outer edge of the right mount bracket 853a. Similarly, the left support portion 852b has a bolt hole (not illustrated) communicating with a bolt hole of a left mount bracket 853b inside the inner wall portion 854b provided so as to surround the outer edge of the left mount bracket 853b.

Further, the rear frame member 86 includes a rear frame portion 861 which extends rearward of the drive unit 70 in the vehicle width direction and a rear support portion 862 which is provided substantially at the center of the rear frame portion 861 in the vehicle width direction. In the rear support portion 862, a circular opening portion 862a penetrating the rear frame portion 861 in the front-rear direction, a boss portion 862b formed so as to surround the opening portion 862a and protruding the rear frame portion 861 in the front-rear direction, a mount insulator 862c made of rubber and arranged in the opening portion 862a, and a collar 862d held by the mount insulator 862c are provided.

In this embodiment, by the bolt inserted from the front of the front frame member 85, the right support portion 852a and the right front fastening portion are fixed via the right mount bracket 853a and the left support portion 852b and the left front fastening portion are fixed via the left mount bracket 853b. Further, the rear support portion 862 and the rear fastening portion 40 are fixed via the mount insulator 862c and the collar 862d by the bolt inserted from the rear of the rear frame member 86. As a result, each fastening portion is fixed to the sub-frame 84 and the drive unit 70 is supported by the sub-frame 84.

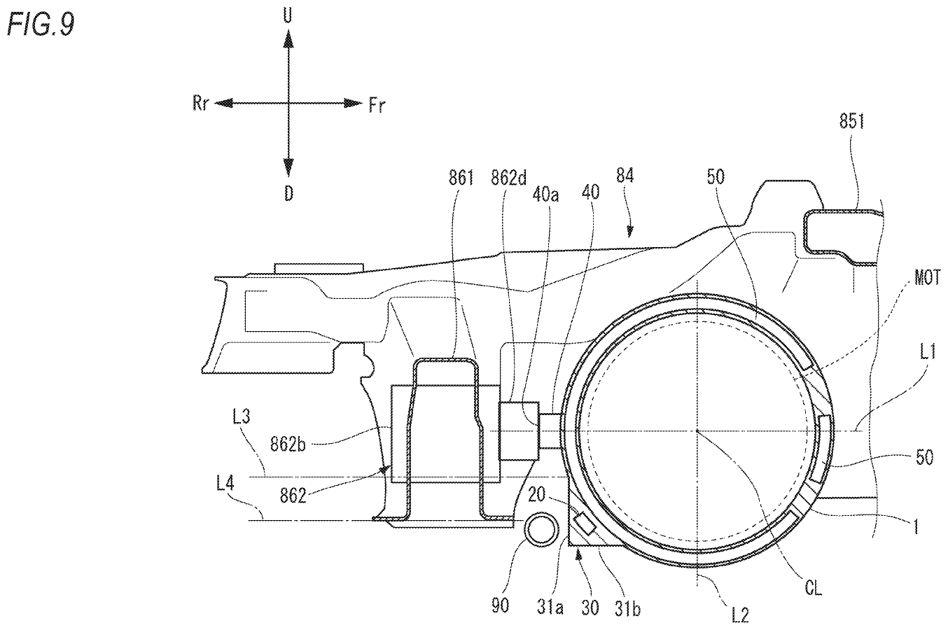

In FIG. 9, an imaginary line L1 is an imaginary line indicating the vertical position of the rotation axis CL of the electric rotary machine MOT. An imaginary line L2 is an imaginary line indicating the position in the front-rear direction of the rotation axis CL of the electric rotary machine MOT. As shown in the imaginary lines, the flat surfaces 31a and 31b are provided below the rotation axis CL and further on the rear side of the vehicle 61 than the rotation axis CL. Thereby, when the drive unit 70 is arranged below the luggage compartment 65, the electric rotary machine case 1 can be protected from flying stones and the like.

Further, as illustrated in FIG. 9, the sub-frame 84 supports the drive unit 70 in a state where the rear frame portion 861 and the protrusion portion 30 face each other in the front-rear direction. When viewed from the rear of the vehicle 61, the protrusion portion 30 overlaps at least a part of the rear frame portion 861.

More specifically, in FIG. 9, an imaginary line L3 indicating the vertical position of the upper end of the flat surface 31a is located above an imaginary line L4 indicating the vertical position of the lower end of the rear frame portion 861. Since the sub-frame 84 supports the drive unit 70 so that the protrusion portion 30 overlaps at least a part of the rear frame portion 861, the rear frame portion 861 can prevent a flying stone or the like from colliding with the protrusion portion 30.

Further, as illustrated in FIG. 9, the end portion of the protrusion portion 30, which is the end portion on the rear frame portion 861 side, that is, the flat surface 31a is located further on the front side than an end portion 40a of the rear fastening portion 40, which is the end portion on the rear frame portion 861 side. Therefore, when the electric rotary machine case 1 is mounted on the vehicle 61, the protrusion portion 30 is located further on the side (front side) away from the rear frame portion 861 than the rear fastening portion 40. By arranging the protrusion portion 30 so as to be located further on the front side than the rear fastening portion 40 in this way, it is possible to prevent the protrusion portion 30 from projecting further on the rear side than the rear fastening portion 40.

Further, in the vehicle 61, a vehicle component 90 may be arranged near the drive unit 70. The vehicle component 90 may be an exhaust pipe which guides exhaust gas generated from the engine ENG to an exhaust port at the rear of the vehicle 61, a transmission, or another vehicle component. In this case, the flat surface 31a is preferably provided at a position facing the vehicle component 90 in the front-rear direction. By thus providing the flat surface 31a so as to face the vehicle component 90 in the front-rear direction, the vehicle component 90 displaced to the drive unit 70 side (that is, electric rotary machine case 1 side) when the vehicle collides can be received by the flat surface 31a. Asa result, it is possible to prevent a large stress from being locally generated in the protrusion portion 30.

Although the embodiment of the invention is described above, the invention is not limited to the embodiment described above and various modifications and improvements can be made as appropriate.

For example, in the embodiment described above, a hybrid vehicle having the engine ENG and the electric rotary machine MOT as the driving source is exemplified, but an electric vehicle having only the electric rotary machine MOT as the driving source may be used. In the embodiment described above, the drive unit 70 is arranged below the luggage compartment 65, but the drive unit 70 may be arranged below the passenger compartment 64.

Further, the drive unit 70 may be provided in the front room 66 instead of the engine ENG and the front wheel FW may be driven by the drive unit 70. Also, in this case, it is preferable to arrange the drive unit 70 so that the power conversion device PDU faces the rear (that is, the passenger compartment 64 side) of the vehicle 61 and the flat surface 31a faces the front (that is, the outer side of the vehicle) of the vehicle 61.

Further, in the embodiment described above, the vehicle component 90 is described as an exhaust pipe which guides the exhaust gas generated from the engine ENG to the exhaust port on the rear side of the vehicle 61. However, it is not limited to this and the vehicle component 90 may be any vehicle component mounted on the vehicle 61.

At least the following matters are described in the present specification. Although the components and the like corresponding to those in the embodiment described above are shown in parentheses, the invention is not limited to this.

(1) An electric rotary machine case (electric rotary machine case 1), which has a cylindrical shape and accommodates an electric rotary machine, (electric rotary machine MOT) the electric rotary machine case includes

a passage (lubricating oil passage 20) extending along a rotation axis direction of the electric rotary machine on an outer periphery of the electric rotary machine, and

a protrusion portion (protrusion portion 30) protruding radially outward from an outer peripheral surface of the electric rotary machine case, the protrusion portion having the passage formed inside the protrusion portion, in which

the protrusion portion has a flat surface (flat surface 31a) in a cross-section orthogonal to a rotation axis of the electric rotary machine.

Since the passage is formed inside the protrusion portion, the rigidity of the protrusion portion is reduced. According to (1), since the protrusion portion has a flat surface, it is possible to prevent a large stress from being locally generated in the protrusion portion when an object comes in contact with the protrusion portion.

(2) The electric rotary machine case according to (1), in which the flat surface is a surface (flat surface 31a) vertically connecting an outermost diameter portion (outermost diameter portion P1) of the protrusion portion and an outer peripheral surface of the electric rotary machine case in the cross-section.

According to (2), the rigidity of the flat surface is improved by making the outermost diameter portion of the protrusion portion and the outer peripheral surface of the electric rotary machine case thick and making the surface connecting them in the up-down direction set as the flat surface.

(3) The electric rotary machine case according to (2), in which the rotation axis of the electric rotary machine extends in a horizontal direction, and the flat surface is longer (length d2) in the rotation axis direction than (length d1) in an up-down direction.

According to (3), the flat surface is longer in the rotation axis direction (that is, in the horizontal direction) than in the up-down direction. Therefore, even when the passage is formed so as to extend in the rotation axis direction, it is possible to prevent the rigidity of the protrusion portion from decreasing.

(4) The electric rotary machine case according to any one of (1) to (3), where

the passage is a passage through which a liquid medium for lubricating or cooling the electric rotary machine passes.

According to (4), the passage formed inside the protrusion portion is the passage through which the liquid medium which lubricates or cools the electric rotary machine passes. In the electric rotary machine case, it is possible to prevent a large stress from being generated in the location where the passage through which the liquid medium passes is provided by setting the flat surface.

(5) A vehicle (vehicle 61) including the electric rotary machine case according to any one of (1) to (4), in which

the electric rotary machine case is arranged below a passenger compartment (passenger compartment 64) or a luggage compartment (luggage compartment 65) of the vehicle, and

the flat surface is provided below the rotation axis and further on a front side or rear side of the vehicle than the rotation axis.

According to (5), the flat surface is provided below the rotation axis and further on a front side or rear side. Therefore, when the electric rotary machine case is disposed under the passenger compartment or the luggage compartment, the electric rotary machine case can be protected from flying stones and the like.

(6) The vehicle according to (5), in which

the electric rotary machine case is supported by a frame member (rear frame member 86) extending in a vehicle width direction, and

the protrusion portion faces the frame member in a front-rear direction of the vehicle and overlaps at least a part of the frame member when viewed from the front-rear direction.

According to (6), since the protrusion portion overlaps at least a part of the frame member when viewed from the front-rear direction of the vehicle, it is possible to prevent the flying stone or the like from colliding with the protrusion portion.

(7) The vehicle according to (6), in which

the electric rotary machine case has a fastening portion (rear fastening portion 40) fastened to the frame member, and

the protrusion portion is located further on a side away from the frame member than the fastening portion.

According to (7), since the protrusion portion is located further on a side away from the frame member than the fastening portion, it is possible to prevent the protrusion portion from projecting further on the frame member side than the fastening portion.

(8) The vehicle according to any one of (5) to (7), in which

the flat surface is provided at a position facing in the front-rear direction with a vehicle component (vehicle component 90) arranged in proximity to the electric rotary machine case in the front-rear direction of the vehicle.

According to (8), the vehicle component and the flat surface face each other. Therefore, since the flat surface can receive the vehicle components displaced toward the electric rotary machine case side when the vehicle collides, it is possible to prevent a large stress from being locally generated in the protrusion portion.

What is claimed is:

1. An electric rotary machine case, which has a cylindrical shape and accommodates an electric rotary machine, the electric rotary machine case comprising:
a passage extending along a rotation axis direction of the electric rotary machine on an outer periphery of the electric rotary machine; and
a protrusion portion protruding radially outward from an outer peripheral surface of the electric rotary machine case, the protrusion portion having the passage formed inside the protrusion portion, wherein
the protrusion portion has a flat surface in a cross-section orthogonal to a rotation axis of the electric rotary machine.

2. The electric rotary machine case according to claim 1, wherein
the flat surface is a surface vertically connecting an outermost diameter portion of the protrusion portion and an outer peripheral surface of the electric rotary machine case in the cross-section.

3. The electric rotary machine case according to claim 2, wherein:
the rotation axis of the electric rotary machine extends in a horizontal direction; and
the flat surface is longer in the rotation axis direction than in an up-down direction.

4. The electric rotary machine case according to claim 1, wherein
the passage is a passage through which a liquid medium for lubricating or cooling the electric rotary machine passes.

5. A vehicle comprising the electric rotary machine case according to claim 1, wherein:
the electric rotary machine case is arranged below a passenger compartment or a luggage compartment of the vehicle; and
the flat surface is provided below the rotation axis and further on a front side or rear side of the vehicle than the rotation axis.

6. The vehicle according to claim 5, wherein:
the electric rotary machine case is supported by a frame member extending in a vehicle width direction; and
the protrusion portion faces the frame member in a front-rear direction of the vehicle and overlaps at least a part of the frame member when viewed from the front-rear direction.

7. The vehicle according to claim 6, wherein:
the electric rotary machine case has a fastening portion fastened to the frame member; and
the protrusion portion is located further on a side away from the frame member than the fastening portion.

8. The vehicle according to claim 5, wherein
the flat surface is provided at a position facing in the front-rear direction with a vehicle component arranged in proximity to the electric rotary machine case in the front-rear direction of the vehicle.
